(19) United States
(12) Patent Application Publication
(10) Pub. No.: US 2023/0047337 A1
(43) Pub. Date: Feb. 16, 2023

(54) ANALYSIS DEVICE

(71) Applicant: NTT DOCOMO, INC., Chiyoda-ku (JP)

(72) Inventors: Hiroki ASAI, Chiyoda-ku (JP); Hisashi KURASAWA, Chiyoda-ku (JP); Yoshinori ISODA, Chiyoda-ku (JP)

(73) Assignee: NTT DOCOMO, INC., Chiyoda-ku (JP)

(21) Appl. No.: 17/759,240

(22) PCT Filed: Dec. 25, 2020
(86) PCT No.: PCT/JP2020/048860

§ 371 Date: Jul. 21, 2022

(30) Foreign Application Priority Data
Feb. 5, 2020 (JP) 2020-018069

(51) Int. Cl. G06F 16/335; G06F 16/35; G06F 40/20

(52) U.S. Cl. CPC G06F 16/335; G06F 16/35; G06F 40/20

(57) ABSTRACT

An analysis device includes a storage unit that stores input sentences in association with information for distinguishing users, an extraction unit that extracts the input sentences stored in the storage unit on a per-user basis for respective corresponding functions, a classification unit that classifies the input sentences into intra-user similarity groups on the per-user basis for respective corresponding functions so that the input sentences extracted by the extraction unit form the intra-user similarity group consisting of input sentences similar to each other, an aggregation unit that aggregates the intra-user similarity groups among users on the per-function basis so that the intra-user similarity groups form an inter-user similarity group consisting of intra-user similarity groups similar to each other, and an output unit that outputs an aggregation result of the aggregation unit.

### TECHNICAL FIELD

An aspect of the present disclosure relates to an analysis device.

### BACKGROUND ART

Conventionally, a dialogue system that acquires an input sentence according to a natural sentence input by a user and executes a function according to the input sentence has become known. Further, in such a dialogue system, there is known a mechanism for presenting an example of an input sentence to a user in order to support an operation by the user. For example, in Patent Literature 1, a function is selected on the basis of a usage history of function execution using voice. Patent Literature 1 presents an example of an input sentence associated with the selected function to a user.

### CITATION LIST

### Patent Literature

[Patent Literature 1] Japanese Unexamined Patent Publication No. 2014-134675

### SUMMARY OF INVENTION

### Technical Problem

In a dialogue system that executes a function on the basis of a natural sentence input by a user, various natural sentences can be used to execute the same function. Therefore, when an example of an input sentence is presented to the user, it is preferable for an input sentence that the user wants to use to be presented. However, in the dialogue system, because input sentences associated with functions are presented in advance, the presented input sentences are likely not to be examples that a large number of users want to use.

An aspect of the present disclosure is to provide an analysis device capable of acquiring input sentences that are used by a large number of users.

### Solution to Problem

An analysis device according to an aspect of the present disclosure is an analysis device that analyzes input sentences input to a terminal device of a user capable of executing functions corresponding to the input sentences, the analysis device including: a storage unit configured to store the input sentences in association with information for distinguishing users; an extraction unit configured to extract the input sentences stored in the storage unit on a per-user basis for respective corresponding functions; a classification unit configured to classify the input sentences extracted by the extraction unit into intra-user similarity groups on the per-user basis for respective corresponding functions so that the input sentences form the intra-user similarity group consisting of input sentences similar to each other; an aggregation unit configured to aggregate the intra-user similarity groups among users on the per-function basis so that the intra-user similarity groups form an inter-user similarity group consisting of intra-user similarity groups similar to each other; and an output unit configured to output an aggregation result of the aggregation unit.

In the analysis device, the input sentences are aggregated so that the inter-user similarity group consisting of intra-user similarity groups that are similar to each other is formed for each function. The intra-user similarity group is formed on the basis of input sentences classified on a per-user basis. That is, input sentences constituting an intra-user similarity group are input by one user. Therefore, the number of intra-user similarity groups constituting the inter-user similarity group is the number of users using the input sentences constituting the inter-user similarity group. It can be said that the inter-user similarity group consisting of a large number of intra-user similarity groups includes input sentences that are used by a large number of users. Therefore, it is possible to acquire the input sentences that are used by a large number of users by using an aggregation result of the aggregation unit.

### Advantageous Effects of Invention

According to an aspect of the present invention, it is possible to provide an analysis device capable of acquiring input sentences that are used by a large number of users.

### BRIEF DESCRIPTION OF DRAWINGS

FIG. 1 is a diagram illustrating a functional configuration of an analysis system including an analysis device, which is an example.

FIG. 2 is a diagram illustrating an example of a reception screen that is presented to a user on a user terminal.

FIG. 3 is a diagram illustrating an example of usage history.

FIG. 4 is a diagram schematically illustrating extraction results of an extraction unit.

FIG. 5 is a diagram schematically illustrating classification results of a classification unit.

FIG. 6 is a diagram schematically illustrating an aggregation result of intra-user similarity groups in an aggregation unit.

FIG. 7 is a diagram illustrating an example of an aggregation result that is output by an output unit.

FIG. 8 is a flowchart illustrating an example of an operation of the analysis device.

FIG. 9 is a diagram illustrating an example of a hardware configuration of the analysis device.

### DESCRIPTION OF EMBODIMENTS

Hereinafter, exemplary embodiments of the present disclosure will be described in detail with reference to the accompanying drawings. In the description of the drawings, the same or equivalent elements are designated by the same reference signs, and duplicate description will be omitted.

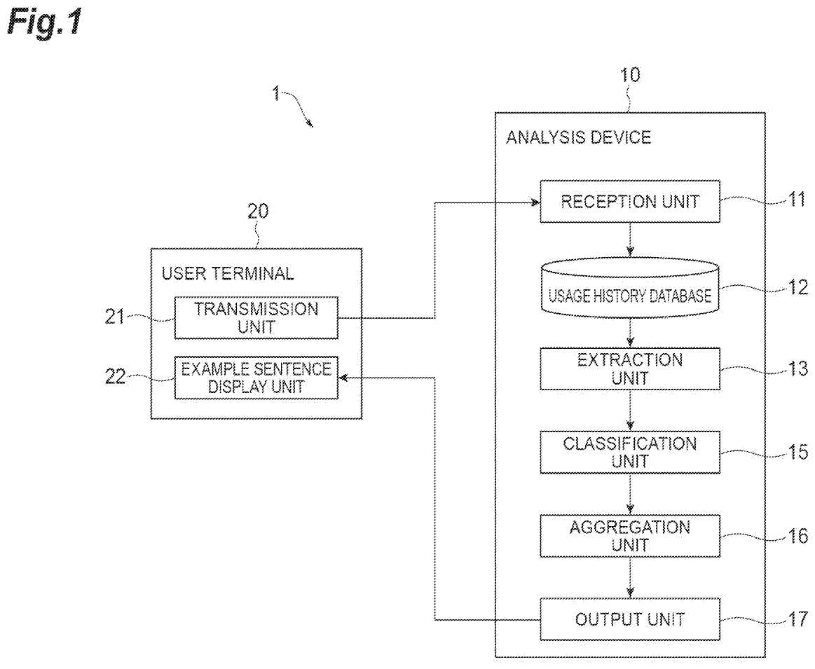

FIG. 1 is a diagram illustrating a functional configuration of an analysis system 1 including an analysis device 10 according to an example. The analysis system 1 includes the analysis device 10 and a plurality of user terminals (terminal devices) 20. The analysis device 10 is, for example, a server device configured to be able to communicate with the user terminal 20. The analysis device 10 may be configured of one device or may be configured of a plurality of devices. The user terminal 20 is, for example, a computer that is operated by the user. As an example, the user and the user terminal 20 have a one-to-one correspondence. The user terminal 20 is a smartphone that is owned by the user. However, a form of the user terminal 20 is not limited to a specific form. Other examples of the user terminal 20 include a tablet terminal, a wearable terminal, a personal computer, a smart speaker, a smart television, and a smart home appliance. Further, one user terminal 20 may be shared by a plurality of users.

The user terminal 20 has a function of providing a dialogue system (a virtual assistant, an artificial intelligence assistant, a digital assistant, or a personal assistant) to the user. The dialogue system is a system that receives an input sentence input by the user and presents an execution result of the function according to an intention of the user that is estimated from the input sentence to the user.

For example, when an input sentence “Tell me how to get to Tokyo Station” is input by the user, the dialogue system activates a route search application on the basis of an analysis result of the input sentence, and presents a route to Tokyo Station to the user. The user terminal 20 has a known function for executing such a dialogue system. For example, the user terminal 20 has a function of receiving an input sentence, a function of analyzing the input sentence through morphological analysis or the like, a function of activating a function corresponding to content of the input sentence according to an analysis result of the input sentence (for example, a function of an application installed in the user terminal 20), and a function of presenting the execution result of the function to the user.

The user terminal 20 may not include all the above-described functions. For example, some (for example, a function of analyzing the input sentence) of the functions may be executed by a first device different from the user terminal 20, which is configured to be able to communicate with the user terminal 20. In this case, for example, the user terminal 20 may transmit an input sentence to the first device and receive an analysis result of the first device from the first device. Further, a function that is specified according to the analysis result (the function corresponding to the input sentence) may not necessarily be executed on the user terminal 20. The function that is specified according to the analysis result may be executed on a second device different from the user terminal 20 configured to be able to communicate with the user terminal 20. In this case, for example, the user terminal 20 may acquire the execution result of the function corresponding to the input sentence from the second device and present the execution result to the user. The first device and the second device may be the same device or may be different devices from each other. Further, the analysis device 10 may function as one or both of the first device and the second device described above.

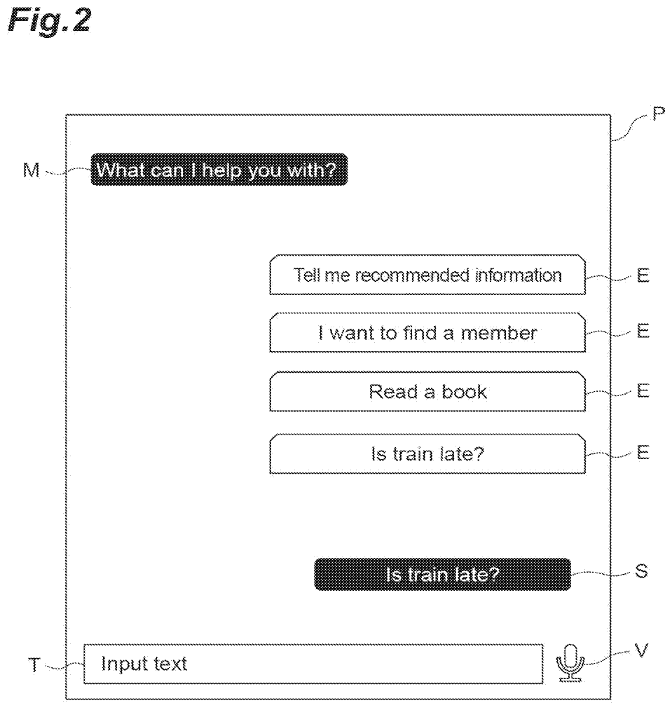

FIG. 2 is a diagram illustrating an example of a reception screen that is presented to the user via the user terminal 20 in the above-described dialogue system. For example, a plurality of icons on a menu screen are displayed on a display of the user terminal 20. A reception screen P is activated by an icon corresponding to the dialogue system being selected by a touch operation of the user or the like. As illustrated in FIG. 2, example sentences E, which are examples of the input sentence, is displayed together with a system message M “What can I help you with?” on the reception screen P. In the example of FIG. 2, four example sentences E including “Tell me recommended information,” “I want to find a member,” “Read a book,” and “Is train late?” are presented to the user.

The user can input an input sentence in a state in which the dialogue system is activated. For example, the user may input an input sentence in a text format by inputting text to a text input window T disposed in a lower part of the reception screen P. Further, the user may input an input sentence in a format of voice data by performing voice input using a voice reception function. The voice reception function is activated by selecting a voice input icon V disposed on the right side of the text input window T. In this case, the input sentence is converted into a text format by using a voice recognition technology. Further, the user may input an input sentence by selecting a desired example sentence from among the example sentences E presented on the reception screen P through a touch operation or the like. Thus, a method of inputting an input sentence in the user terminal 20 is not limited.

The reception screen P in FIG. 2 shows a state in which the input sentence S “Is the train late?” is input to the user terminal 20 by the user through the above series of processing. That is, a case in which “Is the train late?”, which is one of the example sentences E presented on the reception screen P, is used (adopted) by the user is shown. Thereafter, the input sentence S is analyzed, and the function corresponding to the input sentence S is provided to the user. Thus, it is possible to encourage the user to use the dialogue system by presenting an appropriate example sentence E to the user.

In the dialogue system, example sentences that a large number of users want to use are presented so that the user can be effectively encouraged to use the dialogue system. Therefore, the analysis system 1, which is an example, has a function of extracting example sentences used by a large number of users. The dialogue system can present example sentences that are easy for a user to use by referring to the example sentences that are actually used by a large number of users. Hereinafter, such an analysis system 1 will be further described.

The user terminal 20 includes a transmission unit 21 and an example sentence display unit 22. The transmission unit 21 transmits a usage history of the dialogue system of the user to the analysis device 10. The usage history is history information on a per-user basis including information indicating functions corresponding to input sentences, and information indicating times when the functions are executed. When the user uses the dialogue system, the user may register attribute information such as his or her date of birth and sex in the dialogue system.

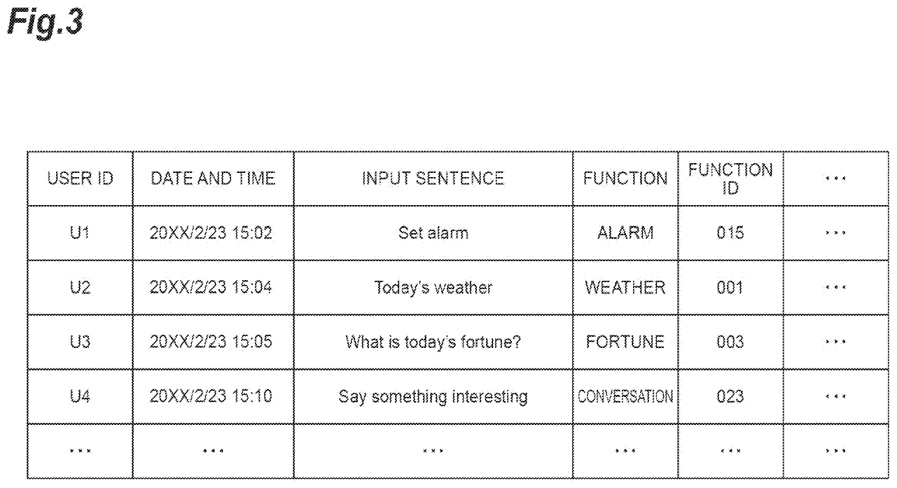

FIG. 3 is a table illustrating an example of usage histories of a plurality of user terminals 20 received by the analysis device 10. In the example of FIG. 3, the usage histories in respective user terminals 20 owned by four users whose user IDs are U1, U2, U3, and U4 are shown. One record (one row) in the table illustrated in FIG. 3 corresponds to one usage history. The usage history may be a history corresponding to one use of the dialogue system. The usage history includes, for example, a “user ID,” a “date and time,” an “input sentence,” a “function,” and a “function ID.” The “user ID” is information for distinguishing users who have used the dialogue system from each other. The “user ID” is, for example, identification information for uniquely specifying a user. The “user ID” can be specified, for example, on the basis of, for example, account information of the user stored in the user terminal 20. The “date and time” is information indicating a time when the function corresponding to the input sentence is executed. The time when the function corresponding to the input sentence is executed does not require any particular temporal strictness. For example, the time when the function corresponding to the input sentence is executed may be a time when the input sentence is input (a point in time when processing for executing the function corresponding to the input sentence is started) or may be a time when an execution result of the function corresponding to the input sentence has been presented to the user (a time when the above processing ends). The “input sentence” is information indicating content of the input sentence input by the user. As an example, the input sentence is configured of text data. The “function” is information indicating a name (for example, a pre-registered application name) of the function corresponding to the input sentence input by the user. That is, the “function” is a name of a function executed by the dialogue system when the user inputs an input sentence. The “function ID” is identification information for uniquely identifying this “function.” In a case in which the attribute information of the user is registered when the dialogue system is used, the attribute information of the user may be included in the usage history.

The example sentence display unit 22 is a functional unit that presents example sentences to the user. As illustrated in FIG. 2, the example sentence display unit 22, which is an example, displays the example sentences E on the reception screen P (a screen shown when waiting for an input from the user) immediately after the dialogue system is activated. In one example, the example sentence E may be transmitted from the analysis device 10 to the user terminal 20. In that case, the example sentence display unit 22 displays the example sentence E received from the analysis device 10. Further, the example sentence E may be transmitted from a device that manages the dialogue system, which is provided separately from the analysis device 10, to the user terminal 20. Further, a plurality of types of example sentences may be prepared in correspondence with the attribute information of the user. For example, when different example sentences are prepared according to an age, sex, and the like, the example sentence display unit 22 may refer to the attribute information of the user to present the example sentence matching the attribute information to the user.

The analysis device 10 includes a reception unit 11, a usage history database (a usage history DB) 12, an extraction unit 13, a classification unit 15, an aggregation unit 16, and an output unit 17. In the analysis device 10, which is one example, a similarity group in which input sentences input by the same user are similar to each other is formed, and similarity groups in which input sentences are similar to each other among different users are aggregated. This makes it possible to acquire a set of similar input sentences input by different users, and the number of similarity groups constituting the set (that is, the number of users). Hereinafter, the analysis device 10 will be described in detail.

The reception unit 11 receives the usage history (see FIG. 3) from each user terminal 20. For example, the reception unit 11 periodically receives the usage history from each user terminal 20 to periodically collect the usage history accumulated in each user terminal 20. The usage history received by the reception unit 11 is stored in the usage history DB (a storage unit) 12. The usage history DB 12 is a database for accumulating the usage history. The usage history stored in the usage history DB 12 from the reception unit 11 includes data of an input sentence associated with information for distinguishing users, and a function corresponding to the input sentence. In one example, the usage history received from each user terminal 20 is stored in the usage history DB as it is.

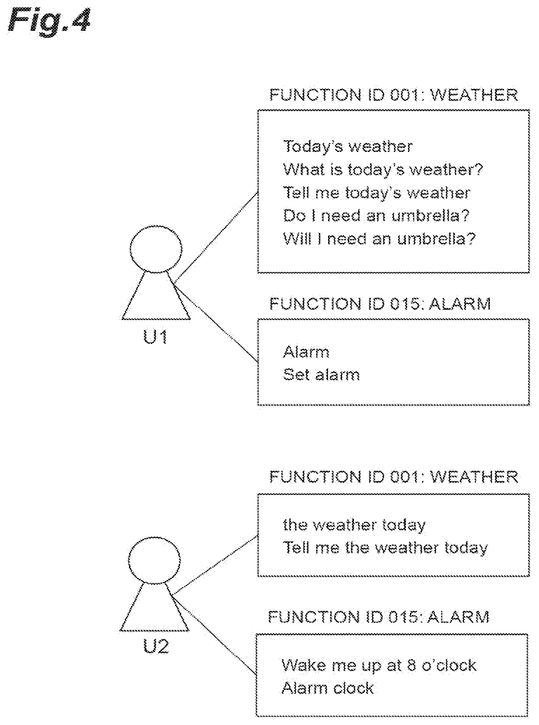

The extraction unit 13 extracts the input sentence stored in the usage history DB 12 for each corresponding function on a per-user basis. FIG. 4 schematically illustrates extraction results of the usage history in the extraction unit. In the example of FIG. 4, for simplicity of description, extraction results of the usage history of the first user and the usage history of the second user are shown. The first user (whose user ID is U1) uses the dialogue system to input input sentences such as “Today's weather,” “What is today's weather,” and “Tell me today's weather,” “Do I need an umbrella,” and “Will I need an umbrella?” to the user terminal in order to activate functions related to weather, and to input input sentences “Alarm” and “Set alarm” to the user terminal in order to activate functions related to an alarm. The second user (whose user ID is U2) inputs the input sentences “The weather today” and “Tell me the weather today” to the user terminal in order to activate the functions related to the weather, and inputs the input sentences of “Wake me up at 8 o'clock” and “Alarm clock” to the user terminal 20 in order to activate the functions related to the alarm. As illustrated in FIG. 4, the extraction unit 13 summarizes, for each function, the input sentences extracted on a per-user basis. In the following description, there are cases in which the user whose user ID is U1 is referred to as a user U1, and the user whose user ID is U2 is referred to as user U2.

In order to extract examples of a frequently used input sentence, the extraction unit 13 may extract only input sentences corresponding to a function executed more than a criterion set in a set period of time. In this case, the extraction criterion may be the number of days each function has been executed. For example, the extraction unit 13 may extract only an input sentence corresponding to a function executed by the user for a predetermined number of days (for example, five days) or more during a predetermined period of time (for example, one month). Further, the extraction criterion may be the number of times each function has been executed. For example, the extraction unit 13 may extract only an input sentence corresponding to a function executed by the user a predetermined number of times (for example, 10 times) or more during the predetermined period of time (for example, one month).

Further, the extraction unit 13 may extract the usage history for each user satisfying a specific condition, on the basis of the attribute information of the user. For example, the extraction unit 13 may divide the users into a plurality of categories with an age, sex, and the like as conditions, and extract the usage history of the user corresponding to each division category. In one example, the extraction unit 13 can divide the users into, for example, men in their 20s, women in their 20s, men in their 30s, women in their 30s, . . . according to attributes, and extract the usage history for each division attribute.

The classification unit 15 classifies the input sentences extracted by the extraction unit 13 into groups for each function on a per-user basis so that the input sentences form a group consisting of input sentences similar to each other (an intra-user similarity group). For example, the classification unit 15 acquires the input sentences for each function with respect to respective user IDs. Then, the classification unit 15 derives a degree of similarity between character strings of the acquired input sentences. For example, the classification unit 15 may derive feature quantities of the respective input sentences and calculate a degree of similarity between the derived feature quantities. As an example, the classification unit 15 divides the input sentence into words through morphological analysis, and calculates a degree of similarity between feature quantities using a set of words (Bag of Words) as a feature quantity (vector). The degree of similarity may be, for example, a cosine similarity degree. The classification unit 15 groups the input sentences to form a group in which the degree of similarity to each other is equal to or higher than a predetermined threshold value.

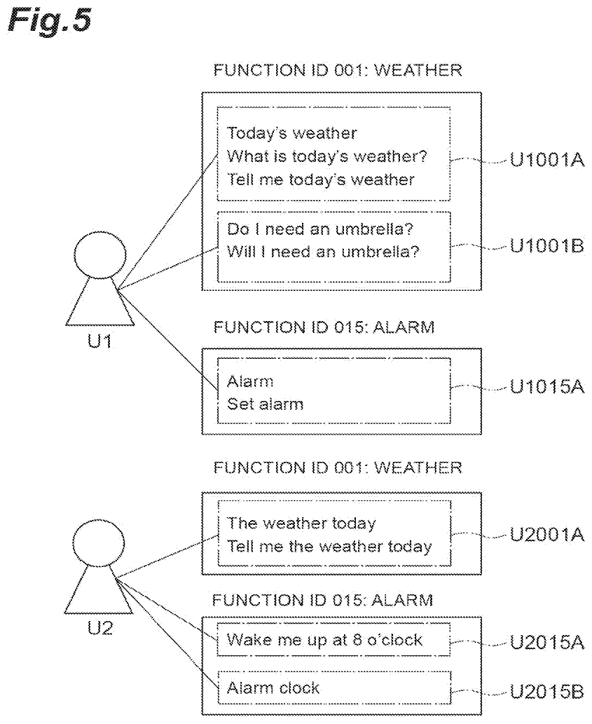

FIG. 5 schematically illustrates a classification result for the intra-user similarity group in the classification unit. In FIG. 5, the extraction results of FIG. 4 are classified into intra-user similarity groups. In the example illustrated in FIG. 5, “Today's weather,” “What is today's weather,” “Tell me today's weather,” “Do I need an umbrella,” and “Will I need an umbrella” extracted as input sentences corresponding to weather associated with the user U1 are grouped into an intra-user similarity group U1001A consisting of “Today's weather,” “What is today's weather,” and “Tell me today's weather,” and an intra-user similarity group U1001B consisting of “Do I need an umbrella,” and “Will I need an umbrella.” Similarly, “Alarm” and “Set alarm” associated with the user U1 and extracted as input sentences corresponding to the alarm are grouped as an intra-user similarity group U1015A, and “The weather today” and “Tell me the weather today” associated with the user U2 and extracted as input sentences corresponding to the weather are grouped as an intra-user similarity group U2001A. A corresponding user ID and function ID may be associated with each intra-user similarity group.

When the extraction unit 13 extracts the usage history for each user who satisfies the specific condition, on the basis of the attribute information of the user, the classification unit 15 may classify input sentences on the basis of the usage history extracted for each specific condition. That is, the classification unit 15 may acquire a classification result for each specific condition.

The aggregation unit 16 aggregates the intra-user similarity groups on a per-function basis among users so that the intra-user similarity groups classified on a per-user basis by the classification unit 15 form an inter-user similarity group consisting of the intra-user similarity groups similar to each other. For example, the aggregation unit 16 acquires the intra-user similarity groups grouped for each user TD with respect to each function. Then, the aggregation unit 16 combines all the input sentences belonging to each intra-user similarity group to generate one sentence (a combination sentence) for each intra-user similarity group. The aggregation unit 16 forms an inter-user similarity group on the basis of a degree of similarity between the combination sentences formed for the respective intra-user similarity groups. The intra-user similarity groups belonging to the same inter-user similarity group have a degree of similarity between the combination sentences that is equal to or higher than a predetermined threshold value. That is, the aggregation unit 16 groups the intra-user similarity groups into the inter-user similarity group so that the degree of similarity between the combination sentences belonging to the group is equal to or higher than the predetermined threshold value. A scheme of deriving the degree of similarity, a grouping criterion, and the like may be the same as or differ from a scheme of deriving the degree of similarity in the classification unit.

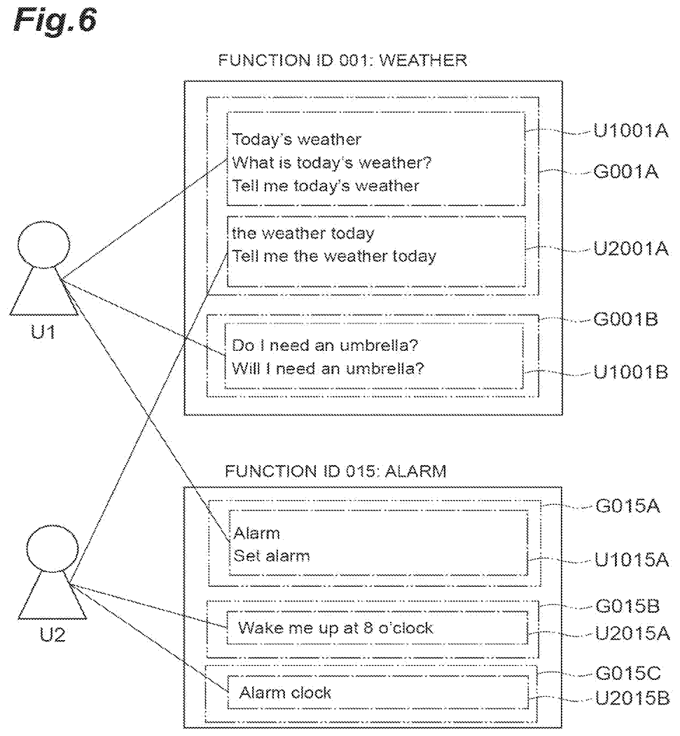

FIG. 6 schematically illustrates aggregation result of the intra-user similarity groups in the aggregation unit 16. In FIG. 6, the classification results of FIG. 5 are aggregated as the inter-user similarity group. In the example illustrated in FIG. 6, an inter-user similarity group G001A in which the intra-user similarity group U1001A classified in association with the user U1 and the intra-user similarity group U2001A classified in association with the user U2 are similar to each other is formed. Further, the intra-user similarity group U1001B classified in association with the user U1 constitutes an inter-user similarity group independently because the intra-user similarity group U1001B does not have a similar intra-user similarity group. Similarly, the intra-user similarity group U1015A, an intra-user similarity group U2015A, and an intra-user similarity group U2015B also constitute an inter-user similarity group G015A, an inter-user similarity group G015B, and an inter-user similarity group G015C, respectively.

Further, the aggregation unit 16 calculates the number of intra-user similarity groups constituting the aggregated inter-user similarity group as the number of users. For example, in the example of FIG. 6, because the inter-user similarity group G001A consists of the intra-user similarity groups U1001A and U2001A, the number of users using the input sentence corresponding to the inter-user similarity group G001A is calculated to be “2”. Because the inter-user similarity groups G001B, G015A, G015B, and G015C are all composed of one intra-user similarity group, the number of users is calculated as “1”.

When the classification unit 15 classifies the input sentences on the basis of the usage history extracted for each specific condition, that is, when the classification result is acquired for each specific condition, the aggregation unit 16 may aggregate the intra-user similarity groups on the basis of the classification results acquired for each specific condition.

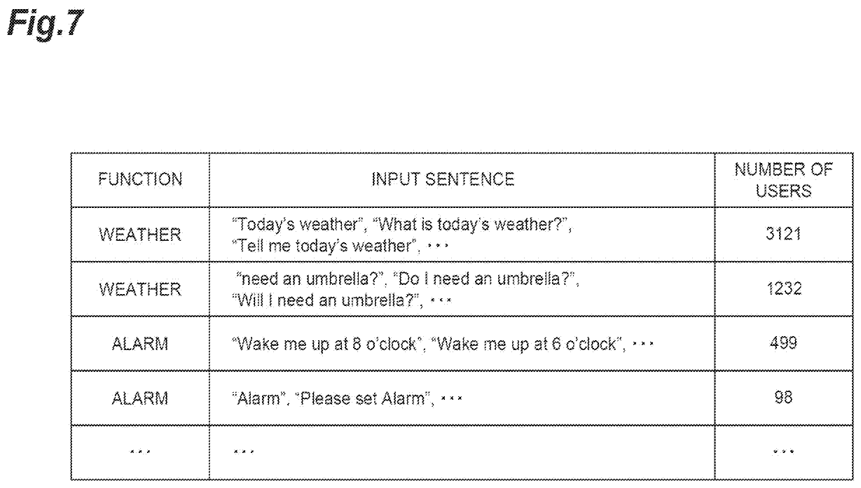

The output unit 17 outputs the aggregation result of the aggregation unit 16. FIG. 7 is a diagram illustrating an example of the aggregation result. As illustrated in FIG. 7, the aggregation result includes a function, an input sentence constituting an inter-user similarity group corresponding to the function, and the number of users who use the input sentence. In the aggregation result, the functions, the input sentences, and the number of users that correspond to each other are associated with each other. The aggregation result may include a total number of users for each function. For example, the aggregation unit 16 may extract a record associated with the same function ID and count the user ID included in the extracted record while removing deduplication to derive the total number of users that have input an input sentence corresponding to each function.

In one example, the output unit 17 may output input sentences that are used by a large number of users to the user terminal 20 as an example sentence. For example, the output unit 17 selects the example sentence from among the input sentences constituting the inter-user similarity group in descending order of the number of users, and outputs the selected example sentence to the user terminal 20. The example sentence may be randomly selected, for example, from among the input sentences constituting the inter-user similarity group. When the aggregation unit 16 has aggregated the intra-user similarity groups on the basis of the classification results acquired for each specific condition, the output unit 17 may output a plurality of types of example sentences for each specific condition.

Further, in another example, an administrator or the like of the analysis device 10 may select an example sentence from among input sentences on the basis of an output result of the output unit 17. For example, the administrator or the like can select an input sentence suitable for the example sentence from among the input sentences constituting the inter-user similarity group corresponding to a desired function while referring to the calculated number of users. The selected input sentence may be registered in the dialogue system as the example sentence E. The administrator or the like may create a new example sentence by referring to the output result. For example, the administrator or the like can create an example sentence of “Wake me up at XX” by referring to the input sentence “Wake me up at 8 o'clock”.

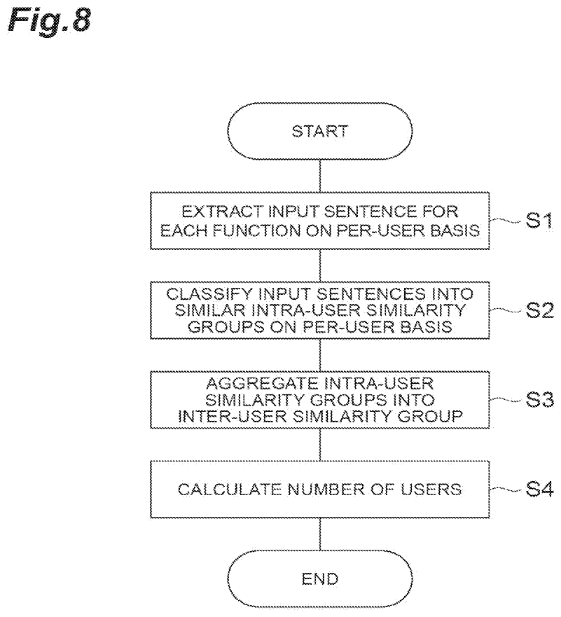

Next, an example of the operation of the extraction unit 13, the classification unit 15, and the aggregation unit 16 of the analysis device 10 will be described with reference to a flowchart illustrated in FIG. 8. That is, in the flowchart of FIG. 8, it is assumed that the usage history transmitted from the transmission unit 21 of the user terminal 20 to the reception unit 11 of the analysis device 10 is stored in the usage history DB 12.

First, the extraction unit 13 extracts the input sentence from the usage history DB 12 (step S1). In step S1, the input sentence is extracted for each function on a per-user basis. That is, the extracted input sentence is associated with at least the user ID and the function. Subsequently, the classification unit 15 classifies the input sentence (step S2). In step S2, the input sentence is classified into an intra-user similarity group for each function on a per-user basis. For example, the classified input sentence may be associated with identification information for identifying the intra-user similarity group. Subsequently, the aggregation unit 16 aggregates the intra-user similarity groups into the inter-user similarity group (step S3). For example, the intra-user similarity group may be associated with identification information for identifying the inter-user similarity group. Subsequently, the aggregation unit 16 calculates the number of intra-user similarity group constituting the inter-user similarity group as the number of users (step S4). For example, the aggregation unit 16 can calculate the number of intra-user similarity groups associated with the inter-user similarity group as the number of users.

As described above, in the analysis device 10, the input sentences input by the plurality of users are aggregated and an inter-user similarity group is formed for each function. This inter-user similarity group consists of one or a plurality of intra-user similarity groups. One intra-user similarity group is a set of input sentences similar to each other among the input sentences that one user has input in correspondence to the function. That is, one intra-user similarity group corresponds to one user. Therefore, an inter-user similarity group consisting of a large number of intra-user similarity groups includes input sentences similar to each other that are used by a large number of users. Thus, it is possible to acquire the input sentences that are used by a large number of users by using the aggregation result of the aggregation unit. Input sentence actually used by a large number of users are highly likely to be input sentences that other users want to use. Therefore, it is possible to display example sentences easy for users to use by being based on the acquired input sentences.

Therefore, in the analysis system 1, the aggregation unit 16 calculates information including the number of intra-user similarity groups constituting the inter-user similarity group as the aggregation result. The number of intra-user similarity groups constituting the inter-user similarity group corresponds to the number of users who use the input sentences constituting the inter-user similarity group. It is possible to easily acquire input sentences that are actually used by a large number of users by deriving the number of users using the aggregation unit 16.

In one example, the extraction unit 13 extracts the input sentences corresponding to the function executed more than the criterion set in the set period of time. For example, the extraction criterion of the extraction unit 13 is the number of days each function has been executed. Thus, it is possible to efficiently extract input sentences corresponding to functions that the user uses on a daily basis by setting the number of days the function has been executed by the user within a predetermined period of times as a threshold value. Further, when the number of executions by the user within the predetermined period of time is set as a threshold value, it is possible to efficiently extract input sentences that are suddenly popular among users. Further, it is possible to reduce a load of calculation in the analysis device 10 by limiting the number of input sentences extracted by the extraction unit 13.

In one example, the usage history DB 12 stores the attribute information of the user in association with the input sentence, and the aggregation unit 16 aggregates the inter-user similarity groups among users whose the pieces of attribute information match at least partially, on a per-function basis. In this configuration, it is possible to acquire an input sentence with a large number of users for each for attributes of the users. For example, when intra-user similarity groups are aggregated on a per-function basis among users having attributes of an age being 30s and a sex being a male, it is possible to acquire the input sentences that are often used by men in the 30s. This makes it possible to generate a suitable example sentence according to the attributes of the users.

Although the example in which the attribute information of the user is the date of birth, sex, and the like has been described, the attribute information may be other information associated with the user, such as position information, hobby and preference, and health condition. For example, when the attribute information includes the position information, an input sentence input in a predetermined range such as a tourist spot may be extracted by the extraction unit. In this case, a large number of input sentences input in the predetermined range can be presented to a user (a user terminal) who has visited the predetermined range.

The block diagram used in the description of the embodiment shows blocks on a per-function basis. These functional blocks (components) are realized by at least any one combination of hardware and software. Further, a method of realizing the respective functional blocks is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but the present disclosure is not limited thereto.

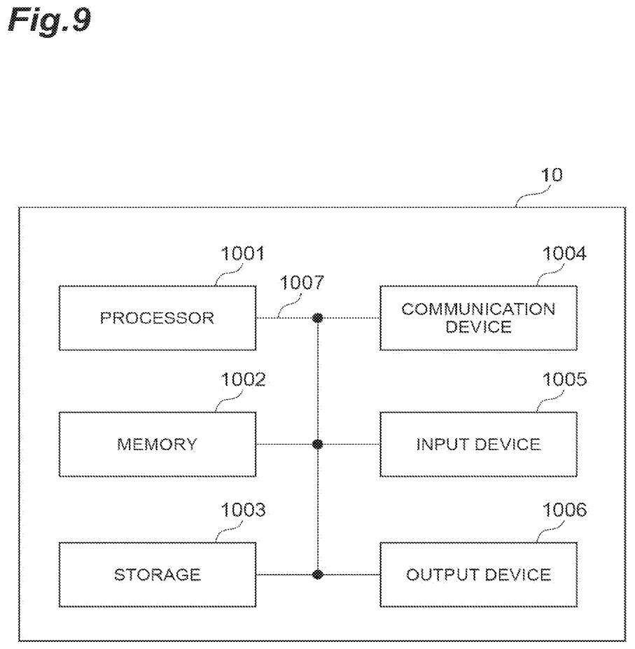

For example, the analysis device 10 in the embodiment of the present disclosure may function as a computer that performs a communication control method of the present disclosure. FIG. 9 is a diagram illustrating an example of a hardware configuration of the analysis device 10 according to the embodiment of the present disclosure. The above-described analysis device 10 may be physically configured as a computer device including a processor 1001, a memory 1002, a storage 1003, a communication device 1004, an input device 1005, an output device 1006, a bus 1007, and the like.

In the following description, the term “device” can be read as a circuit, a device, a unit, or the like. A hardware configuration of the analysis device 10 may be configured to include one or a plurality of devices illustrated in FIG. 1, or may be configured not to include some of the devices.

Each function in the analysis device 10 is realized by loading predetermined software (a program) into hardware such as the processor 1001 or the memory 1002 so that the processor 1001 performs calculation to control communication that is performed by the communication device 1004 or control at least one of reading and writing of data in the memory 1002 and the storage 1003.

The processor 1001, for example, operates an operating system to control the entire computer. The processor 1001 may be configured of a central processing unit (CPU) including an interface with a peripheral device, a control device, a calculation device, a register, and the like.

Further, the processor 1001 reads a program (program code), a software module, or data from at least one of the storage 1003 and the communication device 1004 into the memory 1002 and executes various processes according to the program, the software module, or the data. As the program, a program for causing the computer to execute at least some of the operations described in the above embodiment may be used. For example, the aggregation unit 16 may be realized by a control program stored in the memory 1002 and operating in the processor 1001 and may be realized similarly for other functional blocks. Although the case in which the various processes described above are executed by one processor 1001 has been described, the processes may be executed simultaneously or sequentially by two or more processors 1001. The processor 1001 may be implemented by one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store a program (program code), a software module, or the like that can be executed to perform the communication control method according to an embodiment of the present disclosure.

The storage 1003 is a computer-readable recording medium and may be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The above-described storage medium may be, for example, a database including at least one of the memory 1002 and the storage 1003, a server, or any other appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, each device such as the processor 1001 and the memory 1002 is connected by the bus 1007 for communicating information. The bus 1007 may be configured by using a single bus, or may be configured by using a different bus for each device.

Further, the analysis device 10 may include hardware such as a microprocessor, a digital signal processor (DSP), an application specific integrated circuit (ASIC), a programmable logic device (PLD), and a field programmable gate array (FPGA), and some or all of respective functional blocks may be realized by the hardware. For example, the processor 1001 may be implemented using at least one of these pieces of hardware.

Although the present embodiment has been described in detail above, it is apparent to those skilled in the art that the present embodiment is not limited to the embodiments described in the present specification. The present embodiment can be implemented as a modified and changed aspect without departing from the spirit and scope of the present invention defined by the description of the claims. Accordingly, the description of the present specification is intended for the purpose of illustration and does not have any restrictive meaning with respect to the present embodiments.

A process procedure, a sequence, a flowchart, and the like in each aspect/embodiment described in the present disclosure may be in a different order unless inconsistency arises. For example, for the method described in the present disclosure, elements of various steps are presented in an exemplary order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to being made explicitly, and may be made implicitly (for example, a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless of whether the software may be called software, firmware, middleware, microcode, or hardware description language or called another name.

Further, software, instructions, information, and the like may be transmitted and received via a transmission medium. For example, when software is transmitted from a website, a server, or another remote source using at least one of a wired technology (a coaxial cable, an optical fiber cable, a twisted pair, a digital subscriber line (DSL), and the like) and a wireless technology (infrared rays, microwaves, and the like), the at least one of the wired technology and the wireless technology is included in the definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or any combination of these.

Further, information, parameters, and the like described in the present disclosure may be represented by an absolute value, may be represented by a relative value from a predetermined value, or may be represented by corresponding different information.

Names used for the above-described parameters are not limited names in any way. Further, equations or the like using these parameters may be different from those explicitly disclosed in the present disclosure. Because various information elements can be identified by any suitable names, the various names assigned to these various information elements are not limited names in any way.

The description “based on” used in the present disclosure does not mean “based only on” unless otherwise noted. In other words, the description “based on” means both of “based only on” and “at least based on”.

Any reference to elements using designations such as “first” and “second” as used in the present disclosure does not generally limit the number or order of those elements. These designations can be used in the present disclosure as a convenient way to distinguish between two or more elements. Thus, the reference to the first and second elements does not mean that only two elements can be adopted or that the first element has to precede the second element in some way.

When “include”, “including” and variations thereof are used in the present disclosure, those terms are intended to be comprehensive like the term “comprising”. Further, the term “or” used in the present disclosure is intended not to be an exclusive OR.

In the present disclosure, for example, when an article such as a, an, and the in English is added by translation, the present disclosure may include that a noun following such an article is plural.

In the present disclosure, a sentence “A and B differ” may mean that “A and B are different from each other.” The sentence may mean that “each of A and B is different from C.” Terms such as “separate”, “coupled”, and the like may also be interpreted, similarly to “different.”

### REFERENCE SIGNS LIST

10 Analysis device

11 Reception unit

12 Usage history database (storage unit)

13 Extraction unit

15 Classification unit

16 Aggregation unit

17 Output unit

20 User terminal (terminal device)

1. An analysis device that analyzes input sentences input to a terminal device of a user capable of executing functions corresponding to the input sentences, the analysis device comprising:
a storage unit configured to store the input sentences in association with information for distinguishing users;
an extraction unit configured to extract the input sentences stored in the storage unit on a per-user basis for respective corresponding functions;
a classification unit configured to classify the input sentences extracted by the extraction unit into intra-user similarity groups on the per-user basis for respective corresponding functions so that the input sentences form the intra-user similarity group consisting of input sentences similar to each other;
an aggregation unit configured to aggregate the intra-user similarity groups among users on the per-function basis so that the intra-user similarity groups form an inter-user similarity group consisting of intra-user similarity groups similar to each other; and
an output unit configured to output an aggregation result of the aggregation unit.

2. The analysis device according to claim 1, wherein the aggregation unit calculates information including the number of intra-user similarity groups constituting the inter-user similarity group as the aggregation result.

3. The analysis device according to claim 1, wherein the extraction unit extracts input sentences corresponding to a function executed more than a criterion set in a set period of time.

4. The analysis device according to claim 3, wherein the criterion is the number of days each of the functions has been executed.

5. The analysis device according to claim 1,
wherein the storage unit stores attribute information of the user in association with the input sentences, and
the aggregation unit aggregates the intra-user similarity groups among users whose attribute information matches at least partially, on a per-function basis.
